(19) United States
(12) Patent Application Publication
(10) Pub. No.: US 2026/0261935 A1
(43) Pub. Date: Sep. 3, 2026

(54) CONDITIONAL TRIGGERED MOBILITY SIGNALING

(71) Applicant: QUALCOMM Incorporated, San Diego, CA (US)

(72) Inventors: Punyaslok PURKAYASTHA, San Diego, CA (US); Jelena DAMNJANOVIC, Del Mar, CA (US); Prasada Veera Reddy KADIRI, San Diego, CA (US); Shankar KRISHNAN, Poway, CA (US); Doohyun SUNG, Basking Ridge, NJ (US); Toru UCHINO, Zushi-shi (JP)

(21) Appl. No.: 19/529,792

(22) Filed: Feb. 4, 2026

Related U.S. Application Data
(60) Provisional application No. 63/755,086, filed on Feb. 6, 2025.

(51) Int. Cl. H04W 36/08; H04W 36/24; H04W 36/36

(52) U.S. Cl. CPC H04W 36/08; H04W 36/249; H04W 36/362

(57) ABSTRACT

Certain aspects of the present disclosure provide techniques for conditional triggered mobility. An example method, performed at a central unit (CU), generally includes outputting one or more first messages to prompt one or more distributed units (DUs) to prepare candidate cells for a cell switch associated with a user equipment (UE), wherein the cell switch is associated with a conditional procedure, obtaining, from the one or more DUs, one or more second messages identifying one or more prepared candidate cells, and outputting, to the one or more DUs, one or more third messages indicating the one or more prepared candidate cells identified in second messages.

### CROSS-REFERENCE TO RELATED APPLICATION

This application is a Non-Provisional Application and claims the benefit of U.S. Provisional Application No. 63/755,086 filed Feb. 6, 2025, which is hereby incorporated by reference in its entirety for all applicable purposes.

### FIELD OF THE DISCLOSURE

Aspects of the present disclosure relate to wireless communications, and more particularly, to signaling techniques for conditional triggered mobility.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at a central unit (CU). The method includes outputting one or more first messages to prompt one or more distributed units (DUs) to prepare candidate cells for a cell switch associated with a user equipment (UE), wherein the cell switch is associated with a conditional procedure; obtaining, from the one or more DUs, one or more second messages identifying one or more prepared candidate cells; and outputting, to the one or more DUs, one or more third messages indicating the one or more prepared candidate cells identified in second messages.

Another aspect provides a method for wireless communication at a distributed unit (DU). The method includes obtaining a first message from a central unit (CU); preparing, after obtaining the first message, candidate cells for a cell switch associated with a user equipment (UE), wherein the cell switch is associated with a conditional procedure; outputting, to the CU, one or more second messages identifying one or more prepared candidate cells; and obtaining, from the CU, one or more third messages indicating one or more prepared candidate cells identified by other DUs.

Another aspect provides a method for wireless communication at a user equipment (UE). The method includes obtaining timing alignment timer information associated with one or more candidate cells prepared for a cell switch, wherein the cell switch is associated with a conditional procedure; and utilizing the timing alignment timer information as part of the conditional procedure.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example scenario with a pre-configured candidate cell set.

FIG. 6 depicts an example of UE mobility.

FIG. 7 depicts an example lower-layer triggered mobility (LTM) report without differential reporting.

FIG. 8 depicts a call flow diagram, in accordance with certain aspects of the present disclosure.

FIG. 9 depicts a call flow diagram, in accordance with certain aspects of the present disclosure.

FIG. 10 depicts a method for wireless communications.

FIG. 11 depicts a method for wireless communications.

FIG. 12 depicts a method for wireless communications.

FIG. 13 depicts aspects of an example communications device.

### DETAILED DESCRIPTION

Aspects of the present disclosure provide apparatuses, methods, processing systems, and computer-readable mediums for signaling techniques that may help support conditional triggered mobility.

In advanced wireless systems, mobility procedures are in place to help maintain network connections for a user equipment (UE) as it moves between the coverage areas of different cells. Mobility procedures generally refer to mechanisms that allow a UE to transition from being served by a source cell to being served by a target/candidate cell, which may generally be referred to as handover. The transition can include intra-frequency or inter-frequency mobility and can be triggered by network-side decisions based on UE measurements.

In some cases, for physical layer (PHY or Layer 1/L1) and/or medium access control layer (MAC or Layer 2/L2), also referred to as L1/L2 triggered mobility (LTM), as a UE moves, a new serving cell (e.g. a primary cell (Pcell)) may be selected (e.g., reselected) for handover among a set of pre-configured candidate cells based on measurements of reference signal (RS) made at the physical (PHY or L1) layer (referred to as L1 measurements) for those cells. The RSs are typically sent with different beams. To facilitate a handover decision, the UE may generate beam reports containing information about the received signal quality from the different beams of the serving cell and/or candidate cells. These beam reports may then be sent to a serving cell. For example, such beam reports may include measurements (e.g., reference signal (RS) receive power (RSRP), signal to interference and noise ratio (SINR)) for M beams for each of L (serving and/or candidate) cells. Thus, the reports may include M×L total measurements. Reporting M beams across L cells increases uplink payload size, as well as processing and scheduling overhead at the serving node.

In an open radio access network (O-RAN) scenario, a UE may send a radio resource control (RRC) measurement report. In this context, an RRC measurement report refers to a message sent by the UE to the O-RAN network (e.g., to a distributed unit (DU), containing data about the signal quality of nearby cells. Information in the report may allow the network to make informed decisions like handovers, based on the measured signal strength and other parameters, using the Radio Resource Control (RRC) protocol within the O-RAN architecture.

In some cases, a network such as an O-RAN network may support conditional LTM (CLTM). CLTM generally refers to a procedure where a UE (or other type of device) can switch to a new cell based on certain conditions configured by the network. With CLTM, a UE essentially performs a cell switch, but only when the configured conditions are met. The conditions can include measurement-based triggers and/or threshold comparisons configured by the network and that the UE evaluates locally before execution.

Aspects of the present disclosure provide various signaling mechanisms that may help prepare cells for CLTM, configure a UE with execution conditions for CLTM, and align timing prior to a (CLTM) cell switch. The signaling mechanisms, such as CU-DU preparation signaling, UE configuration signaling, and timing alignment signaling. The signaling mechanisms proposed herein may provide various benefits, such as reduced latency (and interruption time) and improved reliability of conditional switching.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

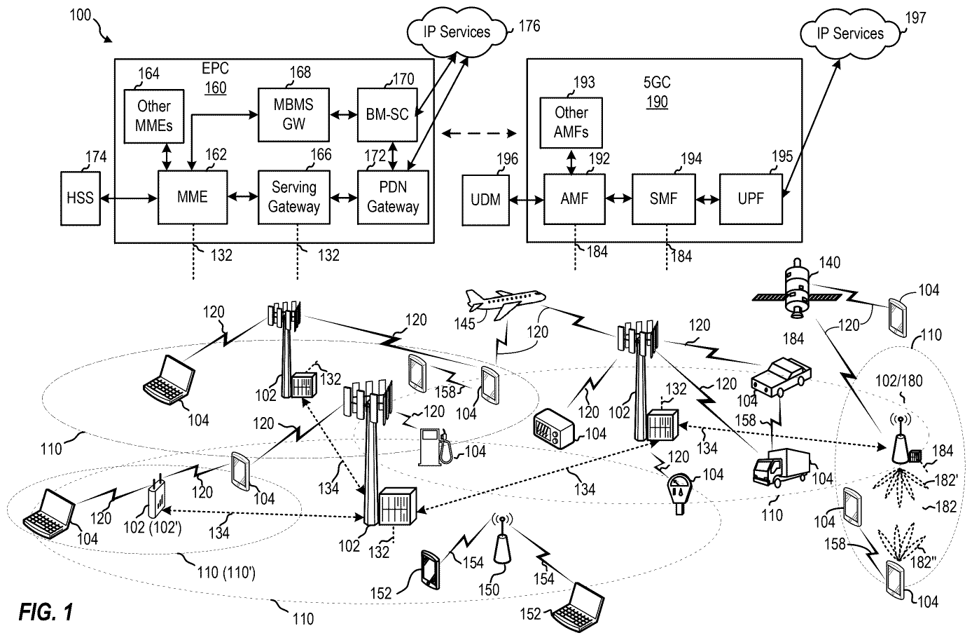

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

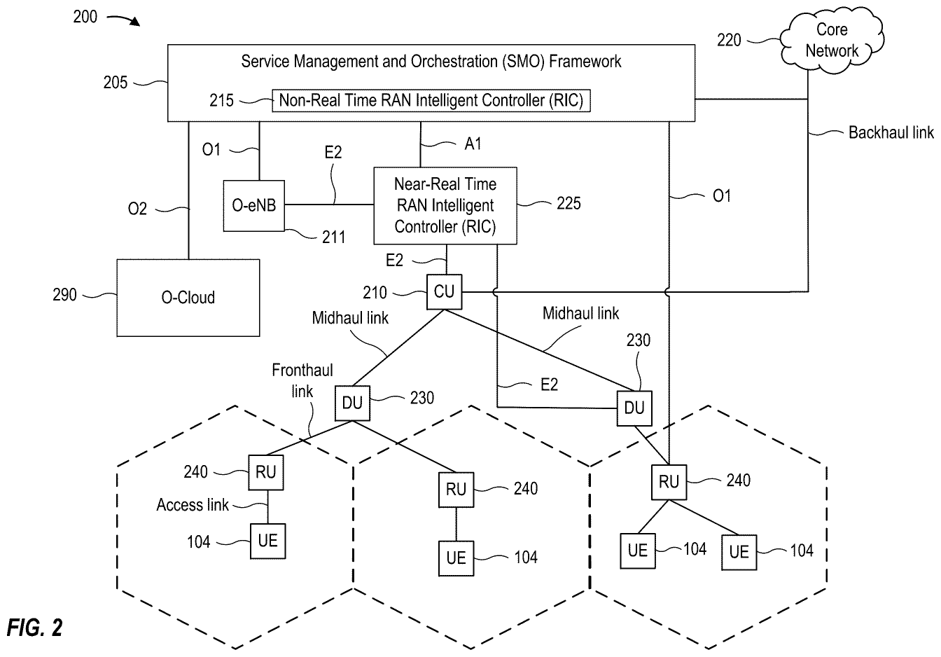

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

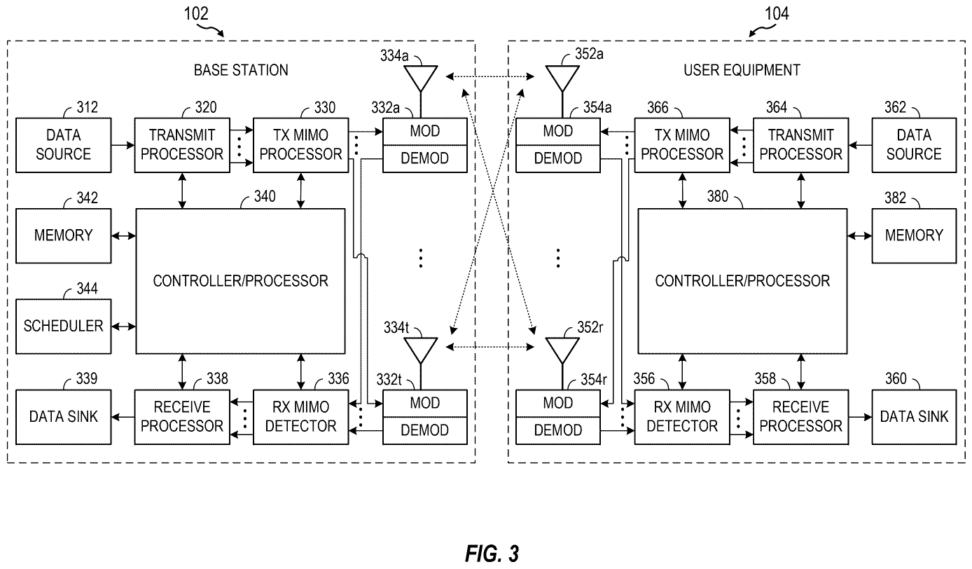

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

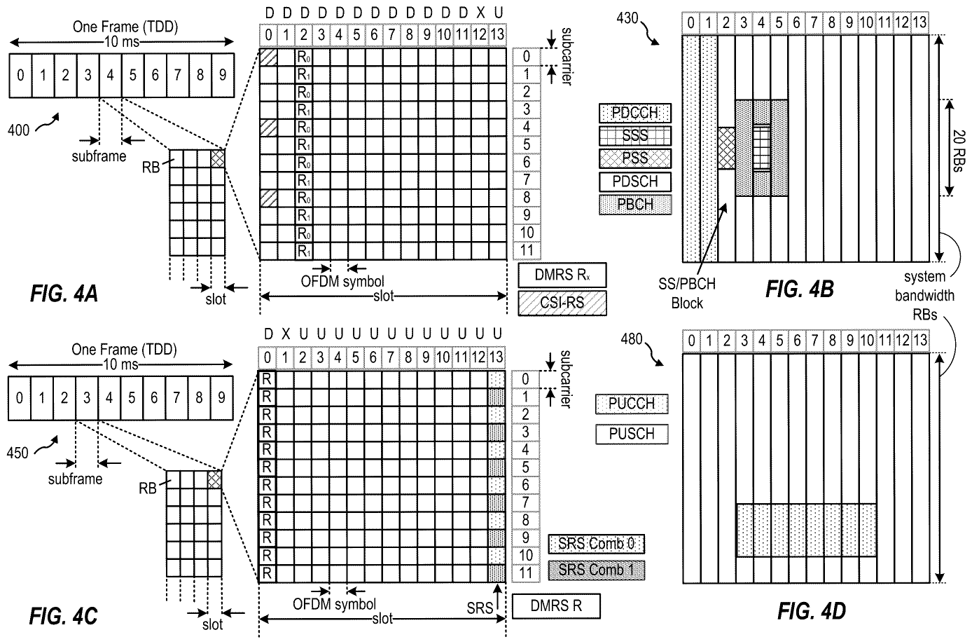

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μslots/subframe. The subcarrier spacing and symbol length/duration are a function of the numerology. The subcarrier spacing may be equal to 2 μ×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Lower-Layer Triggered Mobility (LTM)

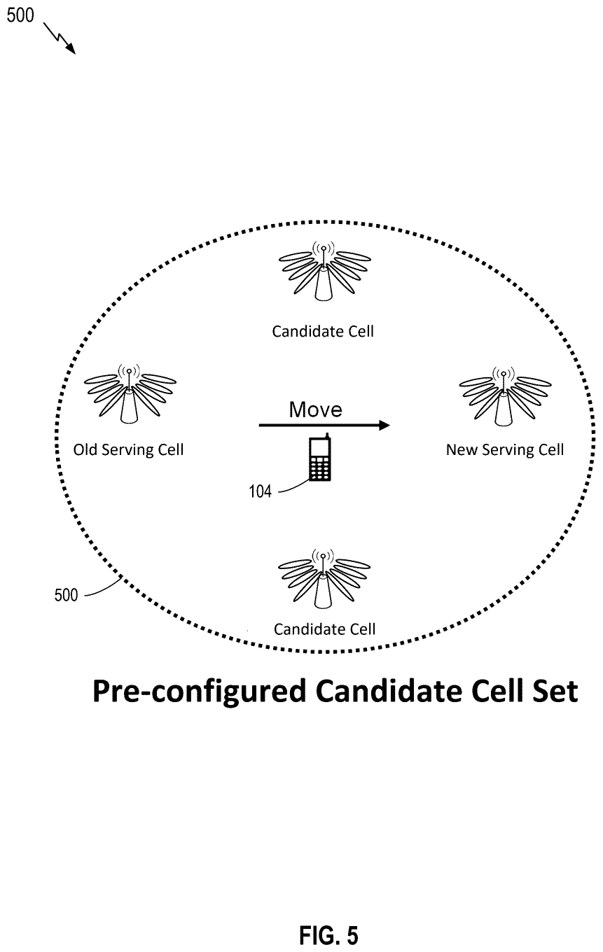

Dynamic mobility signaling may be beneficial in the scenario illustrated in FIG. 5, where a UE may move between a preconfigured set 500 of candidate cells. In the illustrated example, the UE moves from a first cell (e.g., an old serving/primary cell) to a new serving candidate cell. In this case, the UE may not receive data or control information in the candidate cell, but may transmit a PRACH in order to facilitate timing adjustment for the new candidate cell before a cell change.

As noted above, dynamic mobility signaling (e.g., L1 and/or L2-centric mobility or LTM) may lead to more efficient intra-cell and inter-cell mobility with reduced latency.

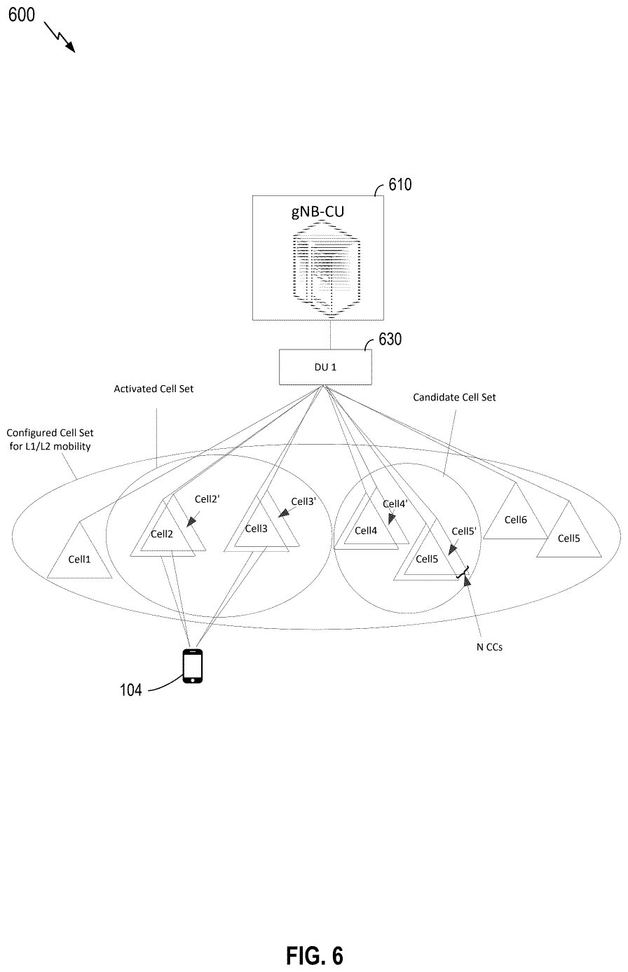

The general concept of LTM signaling may be understood with reference to the example scenario 600 shown in FIG. 6. As illustrated, the network may configure (e.g., via RRC signaling), a set of cells for L1/L2 mobility (referred to herein as an L1/L2 Mobility Configured cell set). At any given time, the network may also configure (via L1/L2 signaling) an L1/L2 Mobility Activated cell set, which refers to a group of cells in the configured set that are activated and can be readily used for data and control transfer. The network may also configure (signal) an L1/L2 Mobility Deactivated cell set, which refers to a group of cells in the configured set that are deactivated and can be readily activated by L1/L2 signaling.

L1/L2 signaling may be used for mobility management of the activated set. For example, L1/L2 signaling may be used to activate/deactivate cells in the set, select beams within the activated cells, and update/switch a primary cell (PCell). This dynamic signaling may help provide seamless mobility within the activated cells in the set. In other words, as the UE moves, the cells from the set are deactivated and activated by L1/L2 signaling. The cells to activate and deactivate may be based on various factors, such as signal quality (measurements) and loading.

As in the example illustrated in FIG. 6, in some cases, all cells in the L1/L2 Mobility Configured cell set may belong to the same DU 630 of a CU 610. This may be similar to carrier aggregation (CA), but cells may be on the same carrier frequencies. The size of the cell set configured for L1/L2 mobility signaling may vary. In general, the cell set size may be selected to be large enough to cover a meaningful mobility area.

In some cases, the UE may be provided with a subset of deactivated cells, as a candidate cell set, from which the UE could autonomously choose to add to the activated cell set. The decision of whether to add a cell from the candidate cell set to the activated cell set may be a based various factors, such as measured channel quality and loading information. In some cases, the ability for the UE to autonomously choose to add to the activated cell set may be similar to a UE decision when configured for Conditional Handover (CHO) for fast and efficient addition of the prepared cells.

As illustrated in FIG. 6, each cell may be served by an RU. Each of the RUs may have multi-carrier (N CCs) support. In such cases, each CC may be a cell (e.g., Cell 2 and Cell 2′ may be different CCs of the same RU). In such cases, activation/deactivation can be done in groups of carriers (cells).

For PCell management, L1/L2 signaling may be used to set (select) the PCell out of the preconfigured options within the activated cell set. In some cases, L3 mobility may be used for PCell change (L3 handover) when a new PCell is not from the activated cell set for L1/L2 mobility. In such cases, RRC signaling may update the set of cells for L1/L2 mobility at L3 handover.

In some cases, physical layer (Layer 1 or L1) measurement may be enhanced for L1/L2 mobility, where a serving cell can be changed via L1/L2 signalling based on L1 measurement, and both synchronous and asynchronous source and target cells may be considered.

Various mechanisms and procedures of L1/L2 based inter-cell mobility may be specified for mobility latency reduction. These may include configuration and maintenance for multiple candidate cells to allow fast application of configurations for candidate cells. Dynamic switching mechanisms among candidate serving cells (including SpCell and SCell) may be supported for the potential applicable scenarios based on L1/L2 signaling.

L1 enhancements for inter-cell beam management, may include L1 measurement and reporting, as well as beam indication. Timing Advance (TA) management and CU-DU interface signaling may also be provided to support L1/L2 mobility.

L1/L2 based inter-cell mobility procedures may be applicable to a variety of scenarios. These scenarios may include standalone, CA and new radio-dual connectivity (NR-DC) cases with serving cell change within one cell group (CG), intra-distributed unit (DU) cases and intra-central unit (CU) inter-DU cases, intra-frequency and inter-frequency scenarios, both FR1 and FR2 scenarios, and scenarios where source and target cells may be synchronized or non-synchronized.

As noted above, a UE may generate beam reports containing information about the received signal quality of RSs transmitted from the different beams of the serving cell and/or candidate cells, facilitating handover decisions. These beam reports may then be sent to the serving cell (base station). For example, such beam reports may include measurements for M beams for each of L (serving and/or candidate) cells.

The UE may provide the report to a serving cell, facilitating handover decisions and mobility procedures. The differential reporting may include various formats, increasing the number of beams that may be reported while significantly reducing overhead associated with processing the beam report.

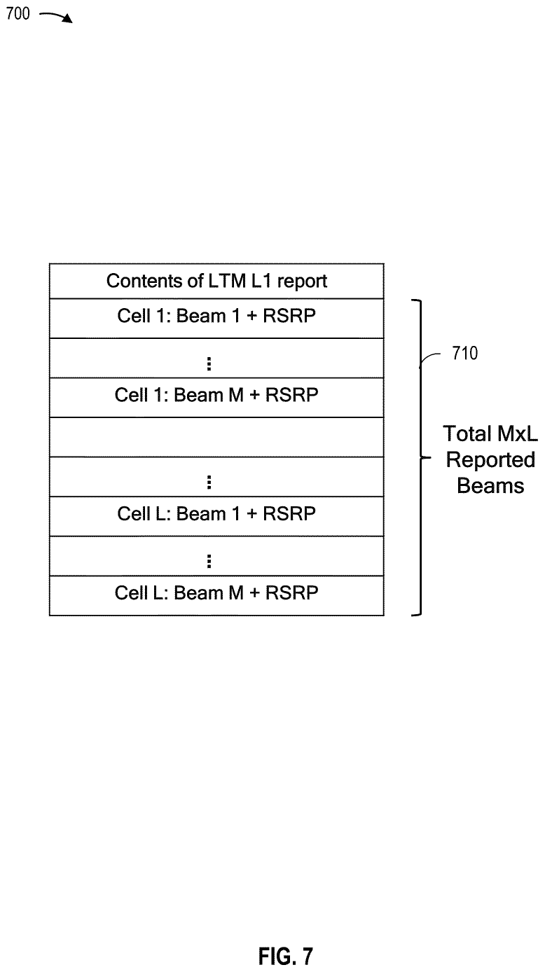

FIG. 7 depicts an example LTM report. As illustrated at 702, a single LTM report may include measurements for M beams for each of L configured (e.g., or activated, if introduced) cells. In some cases, the selection of the M beams may be determined at a UE.

Maximum values of M and L (e.g., the total number of beams that may be reported in a single LTM report) may be based on UE capability. For example, in some cases, M*L=4 beams may be supported as a UE capability. In some cases, the values of M and L may be configured to the UE in a reporting configuration.

As illustrated in FIG. 7, the example LTM report indicates an absolute RSRP value associated with each beam. As noted above, these conventional techniques for beam reporting limit the number of beams that may be included in the report, and are associated with significant overhead.

### Aspects Related to Intra-CU Conditional LTM Preparation Signaling

As noted above, a network such as an O-RAN network may support conditional LTM (CLTM). CLTM generally refers to a procedure where a UE (or other type of device) can switch to a new cell based on certain conditions configured by the network. With CLTM, a UE essentially performs a cell switch, but only when the configured conditions are met.

Aspects of the present disclosure provide various signaling mechanisms that may help prepare cells for CLTM, configure a UE with execution conditions for CLTM, and align timing prior to a (CLTM) cell switch. While aspects of the present disclosure are described with reference to O-RAN networks, the mechanisms proposed herein may be more broadly applicable in any type of network that supports conditional mobility procedures.

Further, while certain aspects of the present disclosure refer to certain operations performed by certain devices, such as CUs, DUs, and UEs-more generally the same or similar operations may be performed by any suitable wireless node. Thus, any reference to CU, DU, or UE should be considered a non-limiting examples of the types of wireless nodes that could perform the operations.

In certain systems that support intra-CU CLTM (e.g., CLTM between cells that belong to DUs of a same CU), various procedures may be performed as part of an LTM preparation phase. For example, a source cell may provide a conditional LTM configuration to a UE via an RRC reconfiguration message. The configuration may include the LTM candidate configurations and the corresponding execution conditions. In this context, L1 execution conditions may refer to UE-evaluable triggers derived from PHY/MAC measurements, while L3 execution conditions may refer to RRC-layer triggers typically tied to standardized measurement events/threshold logic.

In this context, execution conditions refer to conditions which, if met, would result in a cell switch from a source cell to a given candidate cell. A source cell and each candidate cell may provide its own execution condition for conditional LTM.

There are different types of execution conditions, for example, L1 execution conditions (e.g., that involve L1/PHY layer events/measurements) and L3 execution conditions (e.g., that involve L3/RRC layer events/measurements). It is up to a DU to generate the L1 execution condition(s) for a candidate cell. It is up to a CU to generate L3 execution condition(s) for a candidate cell.

The triggering condition of conditional LTM can be based on L3 measurement.

To support initial and subsequent conditional LTM, various items may be considered for the configuration of execution condition(s). The CLTM configuration of each candidate cell may include the execution condition for an initial conditional LTM, which is generated by the initial source cell to trigger the CLTM for the candidate cell. The CLTM configuration of each candidate cell may also include execution conditions for subsequent conditional LTM, which is generated by the candidate cell to trigger the CLTM (e.g., after an initial CLTM) for other candidate cells when the candidate cell becomes a serving cell. Subsequent CLTM conditions may be pre-provisioned so that the UE can continue conditional switching after the first CLTM without requiring a new full preparation phase.

In some cases, physical downlink control channel (PDCCH) ordered early timing alignment (TA) acquisition may be supported for conditional LTM. The Early TA may signaled to the UE from the source cell. In some cases, the network may provide the candidate cell's TA information to a UE via a new medium access control (MAC) control element (CE) MAC CE. This information may include the TA value when UE switches to that candidate cell during CLTM. In some cases, candidate cell TA may be maintained by a new timer. In this context, the TA value is typically candidate-cell specific and a TA value may be maintained per candidate cell or per TA group (TAG).

The present disclosure provides signaling mechanisms that may be used in the LTM preparation phase of Intra-CU conditional LTM. Aspects of the present disclosure also propose various mechanisms for signaling configuration of the TA timer for the LTM candidate cells to the UE.

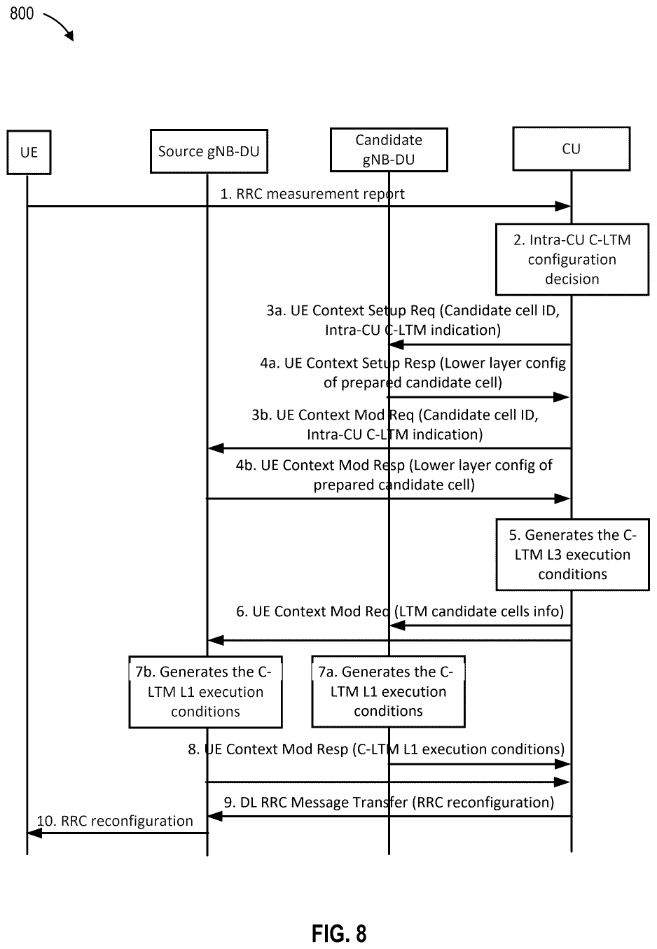

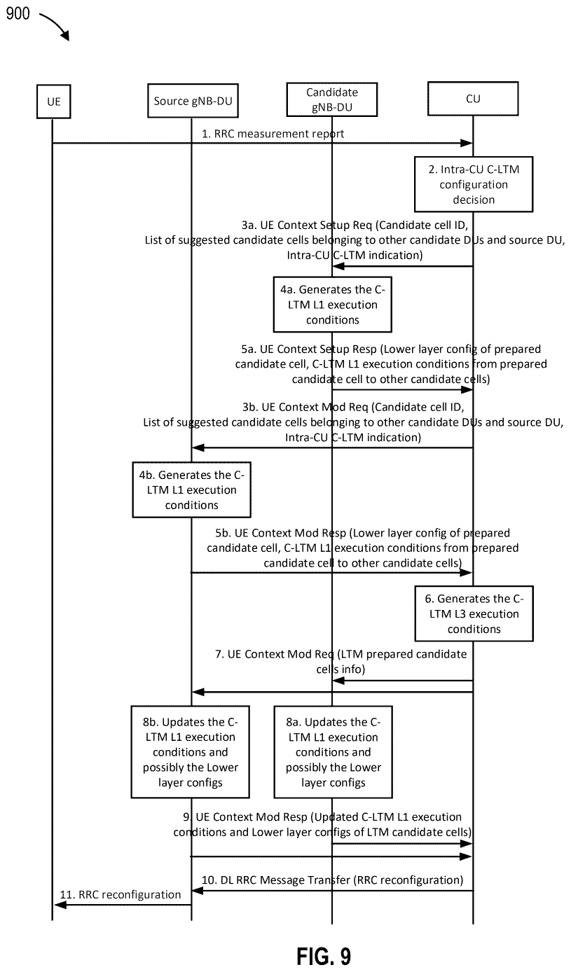

Aspects of the present disclosure may be understood with reference to the call flow diagram 800 of FIG. 8 which shows enumerated steps. In some aspects, the UE shown in FIG. 8 (and FIG. 9) may be an example of the UE 104 depicted and described with respect to FIGS. 1 and 3. In some aspects, the gNB-CU and (source and candidate) gNB-DUs shown in FIG. 8 may be examples the CU 210 and DU 230 depicted and described with respect to FIG. 2.

As illustrated (step 1), the UE may send an RRC measurement report. Based on the RRC measurement reports from the UE, the gNB-CU may prepare of one or more candidate cells for intra-CU conditional LTM (step 2). In some cases, these mechanisms may be designed to reduce interruption time and signaling latency during conditional switching by enabling parallel DU preparation and UE-side trigger evaluation.

As illustrated, the gNB-CU may transmit a signaling message (steps 3a/3b) to an underlying candidate gNB-DU to (prompt the gNB-DU to) prepare a candidate cell. According to certain aspects, the signaling message may include an indication the gNB-DU is to prepare a candidate cell for Intra-CU conditional LTM. The signaling message may also indicate a candidate cell ID (e.g., an ID of a particular candidate cell the gNB-DU is to prepare. In this context, preparing a cell for Intra-CU conditional LTM may include the gNB-DU configuring the cell.

The Intra-CU conditional LTM indication may be needed, for example, due to its impact on the behavior of the receiving nodes. Each candidate gNB-DU may wait to receive information regarding all the prepared LTM candidate cells (which becomes available to the CU after Step 4b), and is transmitted by the source CU to the (e.g., source and candidate) gNB-DUs in Step 6. In this context, preparation may include initiating DU-side candidate cell configuration and collecting the resulting prepared-cell parameters needed for conditional configuration delivery to the UE.

When information regarding all the prepared candidate cells is available, a candidate gNB-DU can generate the L1 execution conditions for a cell switch from its own prepared candidate cell(s) to the other prepared candidate cell(s). These execution conditions may be used for subsequent LTM (e.g., after a candidate cell becomes a source cell). For the same reason, the source gNB-CU can generate the L3 execution conditions only it has the information regarding all the prepared candidate cells (after Step 4b). The preparation of the candidate cells (e.g., performed at the gNB-DUs) can take place in parallel.

As indicated the LTM indication may be conveyed in an LTM configuration request. If the candidate gNB-DU accepts the LTM configuration request, it provides the lower layer configuration of the LTM candidate cell in its response to the gNB-CU (at steps 4a/4b).

According to certain aspects, at step 7 (steps 7a and 7b), a candidate gNB-DU may generate L1 execution conditions for an intra-DU cell switch (e.g., for an LTM cell switch from a prepared candidate cell to other prepared candidate cells within the candidate gNB-DU) and transmit such L1 execution conditions to the gNB-CU in a signaling message (at step 8).

As illustrated, a candidate gNB-DU may generate L1 execution conditions for an intra-DU cell switch, after the preparation of its own candidate cells is completed.

Upon receiving information regarding the prepared candidate cells from its underlying candidate gNB-DUs (e.g., at steps 4a/4b), the gNB-CU may generate the L3 execution conditions for conditional LTM (at step 5). The gNB-CU may generate the L3 execution conditions for cell switch from the source cell to other LTM candidate cells, as well as the execution conditions for cell switch from an LTM candidate cell to other candidate cells (e.g., for subsequent LTM). The gNB-CU may use the UE measurement report(s), received at step 2, to generate the L3 execution conditions.

The gNB-CU may configure the UE with the L3 execution conditions. For example, the gNB-CU transmit the L3 execution conditions to the UE via an RRC reconfiguration message containing the conditional LTM configuration, as indicated at steps 9 and 10.

As illustrated (e.g., at step 6), the gNB-CU may also forward information regarding the prepared candidate cells from its underlying candidate gNB-DUs to each of the candidate gNB-DUs and the source gNB-DU. By providing this information, the source gNB-DU and each candidate gNB-DU will obtain information regarding the LTM candidate cells in the other candidate gNB-DUs.

Upon receiving the information regarding the LTM candidate cells of other candidate gNB-DUs, the source gNB-DU and candidate gNB-DUs may generate L1 execution conditions. For example, the source gNB-DU may generate the L1 execution conditions for the initial LTM cell switch, while each candidate gNB-DU may generate the L1 execution conditions for subsequent LTM cell switch. The source gNB-DU and each candidate gNB-DU may then transmit the L1 execution conditions for the initial LTM cell switch and subsequent LTM cell switch to the gNB-CU in a signaling message (e.g., via a UE Context Mod Response message at step 8). Intra-DU conditions may be generated earlier because the DU already has visibility of its own prepared candidate cells and their beam/measurement configuration.

The gNB-CU collects the L1 execution conditions and transmits them to the UE in the RRC reconfiguration message containing the conditional LTM configuration (at step 9).

FIG. 9 depicts a call flow diagram 900 for an alternative signaling procedure for intra-CU conditional LTM preparation.

In this alternative procedure, the gNB-CU provides more information in the request(s) in steps 3a/b, such as a list of suggested candidate cells. As a result, the gNB-DUs may be able to generate execution conditions sooner (e.g., steps 4a/b) and provide this information to the gNB-CU sooner (at steps 5a/b). In this alternative, steps 7-9 are analogous to (e.g., but a bit different from) original steps 6-8.

Thus, the procedure illustrated in FIG. 9 presents an alternative way for gNB-DUs to generate the L1 execution conditions.

As illustrated, the initial signaling message from the gNB-CU triggering LTM preparation (steps 3a/3b) may include the Intra-CU conditional LTM indication, candidate cell ID, and the list of suggested candidate cells belonging to other candidate DUs and source DU.

Upon receiving the initial signaling message, a candidate gNB-DU and the source gNB-DU generates the C-LTM L1 execution conditions (at steps 4a/4b) from the prepared candidate cell to other candidate cells, and transmits this information in the response message to the gNB-CU (at steps 5a/5b).

The gNB-CU forwards information regarding the prepared candidate cells from its underlying candidate gNB-DUs to each of the candidate gNB-DUs and the source gNB-DU, at step 7.

Upon receiving the information regarding the LTM candidate cells of other candidate gNB-DUs, the source gNB-DU generates the updated L1 execution conditions for the initial LTM cell switch (at step 8b). Similarly, each candidate gNB-DU generates the updated L1 execution conditions for subsequent LTM cell switch (at step 8a). The source gNB-DU and each candidate gNB-DU may also update the lower layer configurations of its prepared candidate cells (e.g., the measurement configuration).

The source gNB-DU and each candidate gNB-DU transmit the updated L1 execution conditions for the initial LTM cell switch and subsequent LTM cell switch to the gNB-CU in a signaling message, at step 9.

Aspects of the present disclosure also provide various mechanisms for signaling configuration of the TA (Timing Alignment) timer for the LTM candidate cells, to the UE.

There are several options for signaling the TA timer for an LTM candidate cell, to the UE. In general, the TA timer value needs to be signaled to the UE, since in conditional LTM, the UE is responsible for checking the validity of the TA.

According to a first option, the gNB-CU transmits, to the UE, the TA timer value for each LTM candidate cell in the RRC reconfiguration message containing the conditional LTM configuration. A single TA timer may be included if the same TA timer value holds for all candidate cells.

TA timer values may also be provided for groups of candidate cells or TA groups (TAGs). The TA timer value can also be provided per candidate cell, and separate values can be provided for the normal uplink (NUL) and the supplemental uplink (SUL).

The UE may start the TA timer for a candidate cell, when it receives the TA value from the source gNB-DU (e.g., in a MAC CE). The gNB-CU may also transmit, to the source gNB-DU, the TA timer value (e.g., using F1-AP signaling). The source gNB-DU can then track the validity of the TA and trigger a PDCCH-order random access channel (RACH) preamble transmission if the TA timer expires. In some cases, a single TA timer (or per-TAG timer) may be applied uniformly to all candidate cells within that scope unless explicitly overridden per-cell/per-link (e.g., NUL vs SUL).

In case of this first option, one possibility is that the UE starts the TA timer upon transmission of the RACH preamble to the candidate cell (e.g., a PDCCH-order RACH). In this case, the UE may restart the TA timer in case the RACH preamble is retransmitted. This approach may account for the overall staleness of the TA, including the backhaul delays in the TA delivery.

According to certain aspects, the UE may have several timer values configured. In such cases, a MAC CE, when delivering the TA, may select one of the configured values and indicate it to the UE. For example, the network may decide on what value to select, depending on what the backhaul experienced/estimated delay is. The UE may then start the timer upon obtaining the information indication which of the configured values to use.

According to a second option, the source gNB-DU may transmit, to the UE, the TA timer value for an LTM candidate cell in a MAC CE. This approach may make sense, for example, when the source gNB-DU is responsible for checking the validity of the TA that it obtains from a candidate gNB-DU during an early TA acquisition procedure. For conditional LTM, it may be assumed that the source gNB-DU can determine a suitable TA timer value to be associated with a TA value (and can transmit an indication of that value to the UE).

According to a third option, a candidate gNB-DU may determine the TA timer value and transmit it to the source gNB-DU, via the gNB-CU, along with the TA value. This information may be conveyed during the early TA acquisition procedure (e.g., the TA Information Transfer procedure may be used for this purpose).

### Example Operations

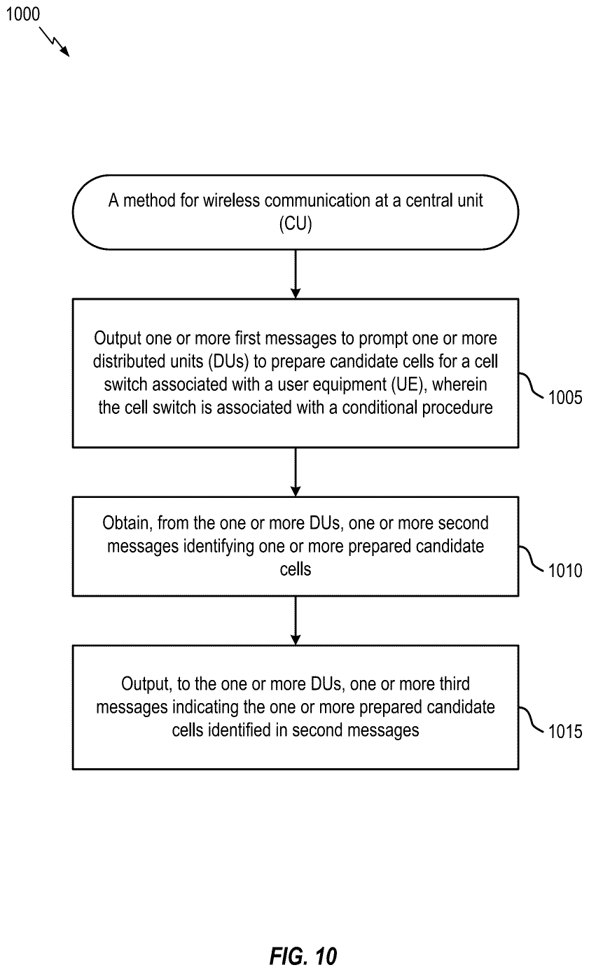

FIG. 10 shows an example of a method 1000 of wireless communication at a central unit (CU), such as a BS 102 of FIGS. 1 and 3, or a disaggregated base station as discussed with respect to FIG. 2.

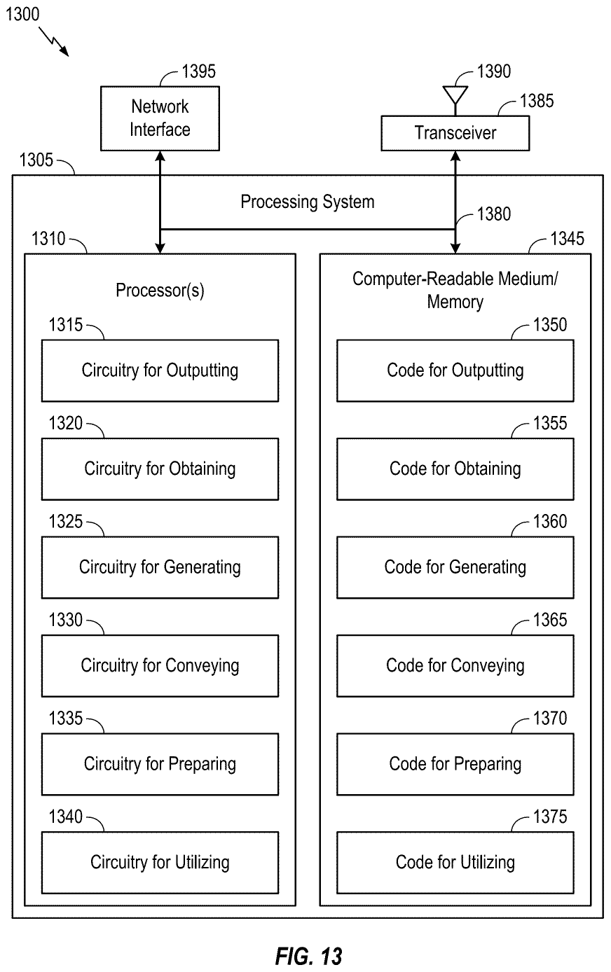

Method 1000 begins at step 1005 with outputting one or more first messages to prompt one or more distributed units (DUs) to prepare candidate cells for a cell switch associated with a user equipment (UE), wherein the cell switch is associated with a conditional procedure. In some cases, the operations of this step refer to, or may be performed by, circuitry for outputting and/or code for outputting as described with reference to FIG. 13.

Method 1000 then proceeds to step 1010 with obtaining, from the one or more DUs, one or more second messages identifying one or more prepared candidate cells. In some cases, the operations of this step refer to, or may be performed by, circuitry for obtaining and/or code for obtaining as described with reference to FIG. 13.

Method 1000 then proceeds to step 1015 with outputting, to the one or more DUs, one or more third messages indicating the one or more prepared candidate cells identified in second messages. In some cases, the operations of this step refer to, or may be performed by, circuitry for outputting and/or code for outputting as described with reference to FIG. 13.

In some aspects, the one or more DUs include a current source DU associated with the UE.

In some aspects, the method 1000 further includes obtaining one or more reports from the UE indicating one or more measurements for cells, and beams transmitted in the cells, associated with the one or more of the DUs, wherein content of the one or more second messages is based on the one or more reports. In some cases, the operations of this step refer to, or may be performed by, circuitry for obtaining and/or code for obtaining as described with reference to FIG. 13.

In some aspects, the method 1000 further includes obtaining one or more reports from the UE indicating one or more measurements for cells associated with of one or more of the DUs. In some cases, the operations of this step refer to, or may be performed by, circuitry for obtaining and/or code for obtaining as described with reference to FIG. 13.

In some aspects, the method 1000 further includes generating execution conditions of a first type for the prepared candidate cells identified in second messages, said generation being based on the one or more reports. In some cases, the operations of this step refer to, or may be performed by, circuitry for generating and/or code for generating as described with reference to FIG. 13.

In some aspects, the method 1000 further includes obtaining, from the DUs, execution conditions of a second type for the prepared candidate cells identified in second messages. In some cases, the operations of this step refer to, or may be performed by, circuitry for obtaining and/or code for obtaining as described with reference to FIG. 13.

In some aspects, the method 1000 further includes outputting at least one fourth message to configure the UE with at least one of the execution conditions of the first type or the execution conditions of the second type. In some cases, the operations of this step refer to, or may be performed by, circuitry for outputting and/or code for outputting as described with reference to FIG. 13.

In some aspects, the method 1000 further includes conveying timing alignment timer information associated with the prepared candidate cells identified in second messages. In some cases, the operations of this step refer to, or may be performed by, circuitry for conveying and/or code for conveying as described with reference to FIG. 13.

In some aspects, the timing alignment timer information is conveyed via the at least one fourth message.

In some aspects, the one or more first messages include a list of one or more candidate cells belonging to the DUs.

In some aspects, the one or more second messages include execution conditions of the second type for the prepared candidate cells identified in second messages.

In some aspects, the method 1000 further includes obtaining, from the DUs, one or more fifth messages indicating one or more updates to the execution conditions for the prepared candidate cells identified in second messages. In some cases, the operations of this step refer to, or may be performed by, circuitry for obtaining and/or code for obtaining as described with reference to FIG. 13.

In some aspects, the method 1000 further includes outputting at least a fifth message configuring the UE with at least one of the execution conditions of the first type or the updated execution conditions of the second type. In some cases, the operations of this step refer to, or may be performed by, circuitry for outputting and/or code for outputting as described with reference to FIG. 13.

In one aspect, method 1000, or any aspect related to it, may be performed by an apparatus, such as communications device 1300 of FIG. 13, which includes various components operable, configured, or adapted to perform the method 1000. Communications device 1300 is described below in further detail.

Note that FIG. 10 is just one example of a method, and other methods including fewer, additional, or alternative steps are possible consistent with this disclosure.

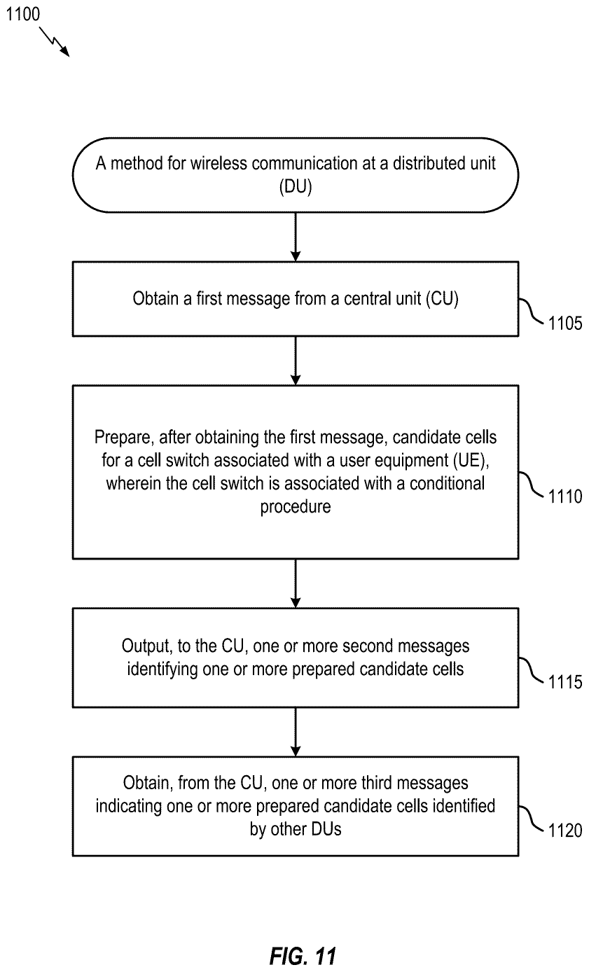

FIG. 11 shows an example of a method 1100 of wireless communication at a distributed unit (DU), such as a BS 102 of FIGS. 1 and 3, or a disaggregated base station as discussed with respect to FIG. 2.

Method 1100 begins at step 1105 with obtaining a first message from a central unit (CU). In some cases, the operations of this step refer to, or may be performed by, circuitry for obtaining and/or code for obtaining as described with reference to FIG. 13.

Method 1100 then proceeds to step 1110 with preparing, after obtaining the first message, candidate cells for a cell switch associated with a user equipment (UE), wherein the cell switch is associated with a conditional procedure. In some cases, the operations of this step refer to, or may be performed by, circuitry for preparing and/or code for preparing as described with reference to FIG. 13.

Method 1100 then proceeds to step 1115 with outputting, to the CU, one or more second messages identifying one or more prepared candidate cells. In some cases, the operations of this step refer to, or may be performed by, circuitry for outputting and/or code for outputting as described with reference to FIG. 13.

Method 1100 then proceeds to step 1120 with obtaining, from the CU, one or more third messages indicating one or more prepared candidate cells identified by other DUs. In some cases, the operations of this step refer to, or may be performed by, circuitry for obtaining and/or code for obtaining as described with reference to FIG. 13.

In some aspects, the DU comprises a current source DU associated with the UE.

In some aspects, the method 1100 further includes generating execution conditions for the prepared candidate cells identified in second messages. In some cases, the operations of this step refer to, or may be performed by, circuitry for generating and/or code for generating as described with reference to FIG. 13.

In some aspects, the method 1100 further includes conveying the execution conditions to the CU. In some cases, the operations of this step refer to, or may be performed by, circuitry for conveying and/or code for conveying as described with reference to FIG. 13.

In some aspects, the first message includes a list of one or more candidate cells belonging to the DUs.

In some aspects, the one or more second messages include execution conditions of the second type for the prepared candidate cells identified in second messages.

In some aspects, the method 1100 further includes outputting, to the CU, one or more fifth messages indicating one or more updates to the execution conditions for the prepared candidate cells identified in second messages. In some cases, the operations of this step refer to, or may be performed by, circuitry for outputting and/or code for outputting as described with reference to FIG. 13.

In one aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative steps are possible consistent with this disclosure.

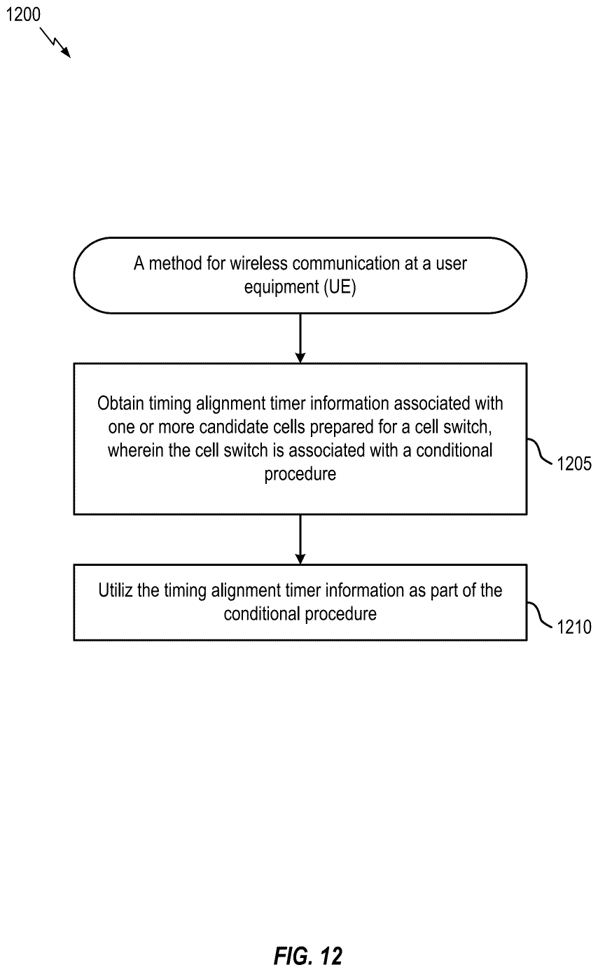

FIG. 12 shows an example of a method 1200 of wireless communication at a user equipment (UE), such as a UE 104 of FIGS. 1 and 3.

Method 1200 begins at step 1205 with obtaining timing alignment timer information associated with one or more candidate cells prepared for a cell switch, wherein the cell switch is associated with a conditional procedure. In some cases, the operations of this step refer to, or may be performed by, circuitry for obtaining and/or code for obtaining as described with reference to FIG. 13.

Method 1200 then proceeds to step 1210 with utilizing the timing alignment timer information as part of the conditional procedure. In some cases, the operations of this step refer to, or may be performed by, circuitry for utilizing and/or code for utilizing as described with reference to FIG. 13.

In some aspects, the timing alignment timer information is obtained via a message that conveys a configuration for the conditional procedure.

In some aspects, the method 1200 further includes outputting a random access channel (RACH) preamble, wherein the utilizing comprises starting a timer, based on a timer value conveyed as part of the timing alignment timer information, upon outputting the RACH preamble. In some cases, the operations of this step refer to, or may be performed by, circuitry for outputting and/or code for outputting as described with reference to FIG. 13.

In some aspects, the UE is configured with a plurality of timer values; and the timing alignment timer information selects one of the plurality of timer values.

In some aspects, the timing alignment timer information is obtained via a medium access control (MAC) control element (CE).

In one aspect, method 1200, or any aspect related to it, may be performed by an apparatus, such as communications device 1300 of FIG. 13, which includes various components operable, configured, or adapted to perform the method 1200. Communications device 1300 is described below in further detail.

Note that FIG. 12 is just one example of a method, and other methods including fewer, additional, or alternative steps are possible consistent with this disclosure.

### Example Communications Device(s)

FIG. 13 depicts aspects of an example communications device 1300. In some aspects, communications device 1300 is a user equipment, such as UE 104 described above with respect to FIGS. 1 and 3. In some aspects, communications device 1300 is a network entity, such as BS 102 of FIGS. 1 and 3, or a disaggregated base station as discussed with respect to FIG. 2.

The communications device 1300 includes a processing system 1305 coupled to the transceiver 1385 (e.g., a transmitter and/or a receiver). In some aspects (e.g., when communications device 1300 is a network entity), processing system 1305 may be coupled to a network interface 1395 that is configured to obtain and send signals for the communications device 1300 via communication link(s), such as a backhaul link, midhaul link, and/or fronthaul link as described herein, such as with respect to FIG. 2. The transceiver 1385 is configured to transmit and receive signals for the communications device 1300 via the antenna 1390, such as the various signals as described herein. The processing system 1305 may be configured to perform processing functions for the communications device 1300, including processing signals received and/or to be transmitted by the communications device 1300.

The processing system 1305 includes one or more processors 1310. In various aspects, the one or more processors 1310 may be representative of one or more of receive processor 358, transmit processor 364, TX MIMO processor 366, and/or controller/processor 380, as described with respect to FIG. 3. In various aspects, one or more processors 1310 may be representative of one or more of receive processor 338, transmit processor 320, TX MIMO processor 330, and/or controller/processor 340, as described with respect to FIG. 3. The one or more processors 1310 are coupled to a computer-readable medium/memory 1345 via a bus 1380. In certain aspects, the computer-readable medium/memory 1345 is configured to store instructions (e.g., computer-executable code) that when executed by the one or more processors 1310, cause the one or more processors 1310 to perform the method 1000 described with respect to FIG. 10, or any aspect related to it; the method 1100 described with respect to FIG. 11, or any aspect related to it; and the method 1200 described with respect to FIG. 12, or any aspect related to it. Note that reference to a processor performing a function of communications device 1300 may include one or more processors 1310 performing that function of communications device 1300.

In the depicted example, computer-readable medium/memory 1345 stores code (e.g., executable instructions), such as code for outputting 1350, code for obtaining 1355, code for generating 1360, code for conveying 1365, code for preparing 1370, and code for utilizing 1375. Processing of the code for outputting 1350, code for obtaining 1355, code for generating 1360, code for conveying 1365, code for preparing 1370, and code for utilizing 1375 may cause the communications device 1300 to perform the method 1000 described with respect to FIG. 10, or any aspect related to it; the method 1100 described with respect to FIG. 11, or any aspect related to it; and the method 1200 described with respect to FIG. 12, or any aspect related to it.

The one or more processors 1310 include circuitry configured to implement (e.g., execute) the code stored in the computer-readable medium/memory 1345, including circuitry for outputting 1315, circuitry for obtaining 1320, circuitry for generating 1325, circuitry for conveying 1330, circuitry for preparing 1335, and circuitry for utilizing 1340. Processing with circuitry for outputting 1315, circuitry for obtaining 1320, circuitry for generating 1325, circuitry for conveying 1330, circuitry for preparing 1335, and circuitry for utilizing 1340 may cause the communications device 1300 to perform the method 1000 described with respect to FIG. 10, or any aspect related to it; the method 1100 described with respect to FIG. 11, or any aspect related to it; and the method 1200 described with respect to FIG. 12, or any aspect related to it.

Various components of the communications device 1300 may provide means for performing the method 1000 described with respect to FIG. 10, or any aspect related to it; the method 1100 described with respect to FIG. 11, or any aspect related to it; and the method 1200 described with respect to FIG. 12, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1385 and the antenna 1390 of the communications device 1300 in FIG. 13. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1385 and the antenna 1390 of the communications device 1300 in FIG. 13.

### Example Clauses

Implementation examples are described in the following numbered clauses:

Clause 1: A method for wireless communication at a wireless node, comprising: outputting one or more first messages to prompt one or more distributed units (DUs) to prepare candidate cells for a cell switch associated with a user equipment (UE), wherein the cell switch is associated with a conditional procedure; obtaining, from the one or more DUs, one or more second messages identifying one or more prepared candidate cells; and outputting, to the one or more DUs, one or more third messages indicating the one or more prepared candidate cells identified in second messages.

Clause 2: The method of Clause 1, wherein the one or more DUs include a current source DU associated with the UE.

Clause 3: The method of any one of Clauses 1-2, further comprising: obtaining one or more reports indicating one or more measurements and beams communicated in the cells, wherein content of the one or more second messages is based on the one or more reports.

Clause 4: The method of any one of Clauses 1-3, further comprising: obtaining one or more reports indicating one or more measurements for cells associated with one or more of the DUs; and generating execution conditions of a first type for the one or more prepared candidate cells identified in second messages, said generation being based on the one or more reports.

Clause 5: The method of Clause 4, further comprising: obtaining, from the one or more DUs, execution conditions of a second type for the one or more prepared candidate cells identified in second messages; and outputting at least one fourth message to configure the UE with at least one of the execution conditions of the first type or the execution conditions of the second type.

Clause 6: The method of Clause 1, further comprising: conveying timing alignment timer information associated with the one or more prepared candidate cells identified in second messages.

Clause 7: The method of Clause 6, wherein the timing alignment timer information is conveyed via the at least one fourth message.

Clause 8: The method of any one of Clauses 1-7, wherein: the one or more first messages include a list of one or more candidate cells belonging to the DUs and the one or more second messages include execution conditions of a first type for the one or more prepared candidate cells identified in the one or more second messages.

Clause 9: The method of Clause 8, wherein the one or more second messages include execution conditions of the second type for the prepared candidate cells identified in second messages.

Clause 10: The method of Clause 8, further comprising: obtaining, from the DUs, one or more fifth messages indicating one or more updated execution conditions of a second type for the one or more prepared candidate cells identified in the one or more second messages; and outputting at least a sixth message to configure the UE with at least one of the execution conditions of the first type or the one or more updated execution conditions of the second type.

Clause 11: A method for wireless communication at a wireless node, comprising: obtaining a first message from a central unit (CU); preparing, after obtaining the first message, candidate cells for a cell switch associated with a user equipment (UE), wherein the cell switch is associated with a conditional procedure; outputting, to the CU, one or more second messages identifying one or more prepared candidate cells; and obtaining, from the CU, one or more third messages indicating one or more prepared candidate cells identified by one or more distributed units (DUs).

Clause 12: The method of Clause 11, wherein the wireless node comprises a current source DU associated with the UE.

Clause 13: The method of any one of Clauses 11-12, further comprising: generating execution conditions for the one or more prepared candidate cells identified in the one or more second messages; and conveying the execution conditions to the CU.

Clause 14: The method of any one of Clauses 11-13, wherein: the first message includes a list of one or more candidate cells belonging to the one or more DUs.

Clause 15: The method of Clause 14, wherein the one or more second messages include execution conditions of the second type for the one or more prepared candidate cells identified in the one or more second messages.

Clause 16: The method of Clause 15, further comprising: outputting, to the CU, one or more fifth messages indicating one or more updates to the execution conditions for the for the one or more prepared candidate cells identified in the one or more second messages.

Clause 17: A method for wireless communication at a wireless node, comprising: obtaining timing alignment timer information associated with one or more candidate cells prepared for a cell switch, wherein the cell switch is associated with a conditional procedure; and using the timing alignment timer information as part of the conditional procedure.

Clause 18: The method of Clause 17, wherein the timing alignment timer information is obtained via a message that conveys a configuration for the conditional procedure.

Clause 19: The method of any one of Clauses 17-18, further comprising: outputting a random access channel (RACH) preamble, wherein the use comprises starting a timer, based on a timer value conveyed as part of the timing alignment timer information, upon outputting the RACH preamble.

Clause 20: The method of any one of Clauses 17-19, wherein: the UE is configured with a plurality of timer values; and the wireless node selects one of the plurality of timer values based on the timing alignment timer information.

Clause 21: The method of any one of Clauses 17-20, wherein the timing alignment timer information is obtained via a medium access control (MAC) control element (CE).

Clause 22: An apparatus, comprising: at least one memory comprising executable instructions; and at least one processor configured to execute the executable instructions and cause the apparatus to perform a method in accordance with any combination of Clauses 1-21.

Clause 23: An apparatus, comprising means for performing a method in accordance with any combination of Clauses 1-21.

Clause 24: A non-transitory computer-readable medium comprising executable instructions that, when executed by at least one processor of an apparatus, cause the apparatus to perform a method in accordance with any combination of Clauses 1-21.

Clause 25: A computer program product embodied on a computer-readable storage medium comprising code for performing a method in accordance with any combination of Clauses 1-21.

Clause 26: An wireless node (e.g., a CU), comprising: at least one transceiver; at least one memory comprising executable instructions; and at least one processor configured to execute the executable instructions and cause the apparatus to perform a method in accordance with any combination of Clauses 1-10, wherein the transceiver is configured to transmit the first messages.

Clause 27: An wireless node (e.g., a DU), comprising: at least one transceiver; at least one memory comprising executable instructions; and at least one processor configured to execute the executable instructions and cause the apparatus to perform a method in accordance with any combination of Clauses 11-16, wherein the transceiver is configured to receive the first message.

Clause 28: An wireless node (e.g., a UE), comprising: at least one transceiver; at least one memory comprising executable instructions; and at least one processor configured to execute the executable instructions and cause the apparatus to perform a method in accordance with any combination of Clauses 17-21, wherein the transceiver is configured to receive the first timing alignment timer information.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for outputting, means for obtaining, means for receiving, means for transmitting, means for selecting, means for generating, means for conveying, means for preparing, means for using, and means for utilizing may comprise one or more processors, such as one or more of the processors described above with reference to FIG. 13.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus, comprising:
at least one transceiver;
at least one memory comprising instructions; and
one or more processors configured to execute the instructions to cause the apparatus to:
transmit, via the at least one transceiver, one or more first messages to prompt one or more distributed units (DUs) to prepare candidate cells for a cell switch associated with a user equipment (UE), wherein the cell switch is associated with a conditional procedure;
receive, from the one or more DUs via the at least one transceiver, one or more second messages identifying one or more prepared candidate cells; and
transmit, via the at least one transceiver to the one or more DUs, one or more third messages indicating the one or more prepared candidate cells identified in one or more second messages.

2. The apparatus of claim 1, wherein the one or more DUs include a current source DU associated with the UE.

3. The apparatus of claim 1, wherein the one or more processors are further configured to execute the instructions to cause the apparatus to:
receive, from the UE via the at least one transceiver, one or more reports indicating one or more measurements and beams communicated in the cells, wherein content of the one or more second messages is based on the one or more reports.

4. The apparatus of claim 1, wherein the one or more processors are further configured to execute the instructions to cause the apparatus to:
receive, from the UE via the at least one transceiver, one or more reports indicating one or more measurements for cells associated with one or more of the DUs; and
generate execution conditions of a first type for the one or more prepared candidate cells identified in the one or more second messages, said generation being based on the one or more reports.

5. The apparatus of claim 4, wherein the one or more processors are further configured to execute the instructions to cause the apparatus to:
receive, from the one or more DUs via the at least one transceiver, execution conditions of a second type for the one or more prepared candidate cells identified in the one or more second messages; and
transmit, via the at least one transceiver, at least one fourth message to configure the UE with at least one of the execution conditions of the first type or the execution conditions of the second type.

6. The apparatus of claim 1, wherein the one or more processors are further configured to execute the instructions to cause the apparatus to:
convey timing alignment timer information associated with the one or more prepared candidate cells identified in the one or more second messages.

7. The apparatus of claim 6, wherein the timing alignment timer information is conveyed via the at least one fourth message.

8. The apparatus of claim 1, wherein:
the one or more first messages include a list of one or more candidate cells belonging to the one or more DUs; and
the one or more second messages include execution conditions of a first type for the one or more prepared candidate cells identified in the one or more second messages.

9. The apparatus of claim 8, wherein the one or more processors are further configured to execute the instructions to cause the apparatus to:
receive, from the one or more DUs via the at least one transceiver, one or more fifth messages indicating one or more updated execution conditions of a second type for the one or more prepared candidate cells identified in the one or more second messages; and
transmit, via the at least one transceiver, at least a sixth message to configure the UE with at least one of the execution conditions of the first type or the one or more updated execution conditions of the second type.

10. An apparatus for wireless communication, comprising:
at least one transceiver;
at least one memory comprising instructions; and
one or more processors configured to execute the instructions to cause the apparatus to:
receive, via the at least one transceiver, a first message from a central unit (CU);
prepare, after receiving the first message, candidate cells for a cell switch associated with a user equipment (UE), wherein the cell switch is associated with a conditional procedure;
transmit, to the CU via the at least one transceiver, one or more second messages identifying one or more prepared candidate cells; and
receive, from the CU via the at least one transceiver, one or more third messages indicating one or more prepared candidate cells identified by one or more distributed units (DUs).

11. The apparatus of claim 10, wherein the apparatus comprises a current source DU associated with the UE.

12. The apparatus of claim 10, wherein the one or more processors are further configured to execute the instructions to cause the apparatus to:
generate execution conditions for the one or more prepared candidate cells identified in the one or more second messages; and
convey the execution conditions to the CU.

13. The apparatus of claim 10, wherein:
the first message includes a list of one or more candidate cells belonging to the one or more DUs.

14. The apparatus of claim 13, wherein the one or more second messages include execution conditions of the second type for the one or more prepared candidate cells identified in the one or more second messages.

15. The apparatus of claim 14, wherein the one or more processors are further configured to execute the instructions to cause the apparatus to:
transmit, to the CU via the at least one transceiver, one or more fifth messages indicating one or more updates to the execution conditions for the one or more prepared candidate cells identified in the one or more second messages.

16. An apparatus for wireless communication, comprising:
at least one transceiver;
at least one memory comprising instructions; and
one or more processors configured to execute the instructions to cause the apparatus to:
receive, via the at least one transceiver, timing alignment timer information associated with one or more candidate cells prepared for a cell switch, wherein the cell switch is associated with a conditional procedure; and
use the timing alignment timer information as part of the conditional procedure.

17. The apparatus of claim 16, wherein the timing alignment timer information is received via a message that conveys a configuration for the conditional procedure.

18. The apparatus of claim 16, wherein the one or more processors are further configured to execute the instructions to cause the apparatus to:
transmit, via the at least one transceiver, a random access channel (RACH) preamble; and
the use comprises starting a timer, based on a timer value conveyed as part of the timing alignment timer information, upon transmitting the RACH preamble.

19. The apparatus of claim 16, wherein:
the apparatus is configured with a plurality of timer values; and
the apparatus selects one of the plurality of timer values based on the timing alignment timer information.

20. The apparatus of claim 16, wherein the timing alignment timer information is via a medium access control (MAC) control element (CE).
